(19) United States
(12) Patent Application Publication
(10) Pub. No.: US 2010/0068115 A1
(43) Pub. Date: Mar. 18, 2010

(54) SILICON RECLAMATION APPARATUS AND METHOD OF RECLAIMING SILICON

(76) Inventors: Kimihiko Kajimoto, Osaka (JP); Yoshiyuki Hojo, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/513,191

(22) PCT Filed: Oct. 15, 2007
(86) PCT No.: PCT/JP2007/070092

§ 371 Date: May 1, 2009

(30) Foreign Application Priority Data
Nov. 2, 2006 (JP) 2006-299513

(51) Int. Cl. C01B 33/02; C01B 33/037; B03C 1/00; B07B 9/00

(52) U.S. Cl. 423/349; 422/243; 422/307

(57) ABSTRACT

A silicon reclamation apparatus with which a large amount of silicon can be easily recovered from a waste slurry is provided.

The silicon reclamation apparatus of the present invention includes a solid-liquid separation part for obtaining solid substances for silicon recovery by solid-liquid separation of a concentrate of a waste slurry or the waste slurry which is discharged from a cutting device which cuts silicon or a polishing device which polishes silicon, with use of a slurry comprising abrasive grains and coolant; a washing part in which the solid substances for silicon recovery are washed with an organic solvent; and a classification part in which the solid substances for silicon recovery after the washing are classified to obtain a silicon-containing powder having a higher silicon content than before the classification.

### TECHNICAL FIELD

The present invention relates to a silicon reclamation apparatus and a method of reclaiming silicon for obtaining reclaimed silicon having a higher silicon content from a waste slurry used in production steps of a silicon wafer or the like.

### BACKGROUND ART

In production steps of thin plates (hereinafter, referred to as a “silicon wafer”) made of silicon monocrystal or silicon polycrystal, which are in widespread use as materials for an IC chip or a solar cell, about 60% of raw material silicon is disposed of in a waste liquid during cutting, chamfering or polishing silicon, and therefore the impact on the product cost and the burden on the environment associated with disposal of silicon (a waste liquid is generally subjected to disposal by landfill after concentrating a waste liquid or recovering a part of materials from the waste liquid) become large problems.

Further, particularly in recent years, production volumes of solar cells have kept on increasing and demands on raw material silicon have grown rapidly. Therefore, a shortage of silicon for a solar cell becomes actual.

Hence, methods of recovering silicon from a waste liquid produced during production of a silicon wafer, for example, cutting or polishing described above, have been proposed.

In Patent Document 1, for example, solid substances are recovered from a waste slurry discharged from processing of cutting or polishing a monocrystalline silicon ingot or a polycrystalline silicon ingot using a slurry obtained by dispersing abrasive grains in a coolant, and recovered solid substances are subjected to washing by an organic solvent for removing a coolant and the like, water-washing for washing the organic solvent away, acid-washing for dissolving metals (iron, copper, etc.) contained in the waste slurry in an aqueous acid solution (an aqueous solution of hydrofluoric acid, etc.) to remove it, and water-washing for washing the aqueous acid solution away.

### Patent Document 1: Japanese Kokai Publication No. 2001-278612

### DISCLOSURE OF THE INVENTION

### Problems to be Solved by the Invention

As shown in Patent Document 1, conventionally, a larger number of steps have been required for recovering silicon from a waste slurry.

Further, as shown above, silicon is a precious material and it is desired to recover a large amount of silicon easily from the waste slurry.

The present invention was made in view of the above circumstances and it is an object of the present invention to provide a silicon reclamation apparatus with which a large amount of silicon can be easily recovered from a waste slurry.

### Means for Solving the Problems

The silicon reclamation apparatus of the present invention is a silicon reclamation apparatus including a solid-liquid separation part for obtaining solid substances for silicon recovery containing silicon chips by solid-liquid separation of a concentrate of a waste slurry or the waste slurry which is a mixture of a slurry and the silicon chips obtained by cutting or polishing a silicon chunk or a silicon wafer with use of the slurry comprising abrasive grains and coolant, a washing part in which the solid substances for silicon recovery are washed with an organic solvent, and a classification part in which the solid substances for silicon recovery from the washing part are classified to obtain a silicon-containing powder having a lower abrasive grain content and a higher silicon content than before the classification.

The present inventors made intensive investigations and consequently found that an acid-washing step or a, water-washing step included in a conventional process has drawbacks of reducing a silicon recovery rate and increasing number of steps or facilities for silicon recovery for the following reasons.

(1) Most of silicon contained in solid substances recovered from a waste slurry is highly reactive because it is in a form of fine particles (for example, when abrasive grains of #800 or less are used, silicon becomes fine particles having a particle diameter of 1 μm or larger and 10 μm or smaller and an aggregate thereof), and part (most depending on the conditions) of the silicon is dissolved in an aqueous acid solution. Therefore, a silicon recovery rate is reduced.
(2) In the water-washing step (it is thought to be essential after acid-washing), silicon dioxides are produced at the surfaces of these silicon fine particles by a reaction with water to cause a reduction in silicon recovery rate. Further, a reduction of the silicon dioxides causes increases in silicon recovery tact (a reduction reaction time) and silicon recovery cost.
(3) in order to dissolve and remove silicon dioxide and metals using an aqueous solution of hydrofluoric acid or the like, large-scale facilities are required because collection of acid gases or generated gases (hydrogen gas) and treatment or disposal of the acid solution after acid-washing are needed, and these steps cause silicon recovery cost to increase.

Based on the above-mentioned findings, the present inventors found that by washing the solid substances for silicon recovery with an organic solvent instead of washing the solid substances for silicon recovery with water or an aqueous acid solution, reduction in a silicon recovery rate can be prevented and the steps for silicon recovery or facilities for silicon recovery can be simplified. These findings have now led to completion of the present invention.

Hereinafter, a preferable embodiment of the present invention will be described.

Preferably, the solid-liquid separation part, the washing part and the classification part are configured in such a way that the solid substances for silicon recovery or the silicon-containing powder does not come into contact with water, an aqueous acid solution or a solution predominantly composed of at least one of water and the aqueous acid solution. In this case, contact between the solid substances for silicon recovery or the silicon-containing powder and water and/or the aqueous acid solution is avoided and the reduction in a silicon recovery rate can be prevented with more reliability.

Preferably, the waste slurry contains metal chips mixed during cutting or polishing a silicon chunk or a silicon wafer, and in the classification part, a metal-containing powder having a higher metal content than before the classification is removed. In this case, a ratio of metal contained in the silicon-containing powder can be reduced.

Preferably, the waste slurry contains ferromagnetic metal chips mixed during cutting or polishing a silicon chunk or a silicon wafer, and the silicon reclamation apparatus further contains a metal chips removal part eliminating the metal chips using a magnetic field. In this case, a ratio of metal contained in the silicon-containing powder can be reduced.

Preferably, the silicon reclamation apparatus further contains a molding part in which a pressure is applied to the silicon-containing powder to granulate it. If granulating the silicon-containing powder, there are advantages that (1) handling of the silicon-containing powder becomes easy and (2) thermal conductivity between particles is improved.

Preferably, the silicon reclamation apparatus further contains a heating part in which the silicon-containing powder before granulation or after granulation is fired at a temperature lower than a melting point of silicon and then melted at a temperature of a melting point of silicon or higher. In this case, organic residue can be removed by firing at low temperature and then the silicon-containing powder can be melted at elevated temperature.

Preferably, the silicon reclamation apparatus further contains a purification part, which eliminates impurities contained in a silicon-containing melt obtained by melting the silicon-containing powder. In this case, an impurity concentration of the resulting reclaimed silicon can be reduced.

The present invention also provides a method of reclaiming silicon, containing a solid-liquid separation step in which solid substances for silicon recovery containing silicon chips are obtained by solid-liquid separation of a concentrate of a waste slurry or the waste slurry which is a mixture of a slurry and the silicon chips obtained by cutting or polishing a silicon chunk or a silicon wafer with use of the slurry comprising abrasive grains and coolant, a washing step in which the solid substances for silicon recovery are washed with an organic solvent, and a classification step in which the solid substances for silicon recovery from the washing step are classified to obtain a silicon-containing powder having a lower abrasive grain content and a higher silicon content than before the classification.

Preferably, the solid-liquid separation step, the washing step and the classification step are performed in such a way that the solid substances for silicon recovery or the silicon-containing powder does not come into contact with water, an aqueous acid solution or a solution mainly composed of at least one of water and the aqueous acid solution.

Preferably, the waste slurry contains metal chips mixed during cutting or polishing a silicon chunk or a silicon wafer, and in the classification step, a metal-containing powder having a higher metal content than before the classification is removed.

Preferably, the waste slurry contains ferromagnetic metal chips mixed during cutting or polishing a silicon chunk or a silicon wafer, and the method of reclaiming silicon further contains a metal chips removal step of eliminating the metal chips using a magnetic field.

Preferably, the method of reclaiming silicon further contains a molding step of applying a pressure to a silicon-containing powder to granulate it.

Preferably, the method of reclaiming silicon further includes a heating step in which the silicon-containing powder before granulation or after granulation is fired at a temperature lower than a melting point of silicon and then melted at a temperature of a melting point of silicon or higher.

Preferably, the method of reclaiming silicon further includes a purification step of eliminating impurities contained in a silicon-containing melt obtained by melting the silicon-containing powder in a heating step.

Various embodiments described above can be combined with one another.

### BRIEF DESCRIPTION OF THE DRAWINGS

FIG. 1 is a block diagram showing a constitution of a silicon reclamation apparatus of a first embodiment of the present invention.

FIG. 2 is a block diagram showing an example of a first constitution of a solid-liquid separation part in FIG. 1.

FIG. 3 is a block diagram showing an example of a second constitution of a solid-liquid separation part in FIG. 1.

### DESCRIPTION OF THE REFERENCE NUMERALS AND SYMBOLS

1: Solid-liquid separation part, 3: washing part, 5: classification part, 7: drying and pulverization part, 9: metal chips removal part, 11: molding part, 13: heating part, 15: purification part, 17: solidification part, 19: primary centrifugal separator, 21: secondary centrifugal separator, 23: distillation apparatus, 23a: first distillation apparatus, 23b: second distillation apparatus

### BEST MODE FOR CARRYING OUT THE INVENTION

Hereinafter, an embodiment of the present invention will be described by use of drawings. Constitutions shown in drawings or the following description is just exemplifications and the scope of the present invention is not limited to constitutions shown in drawings or the following description.

### 1. First Embodiment

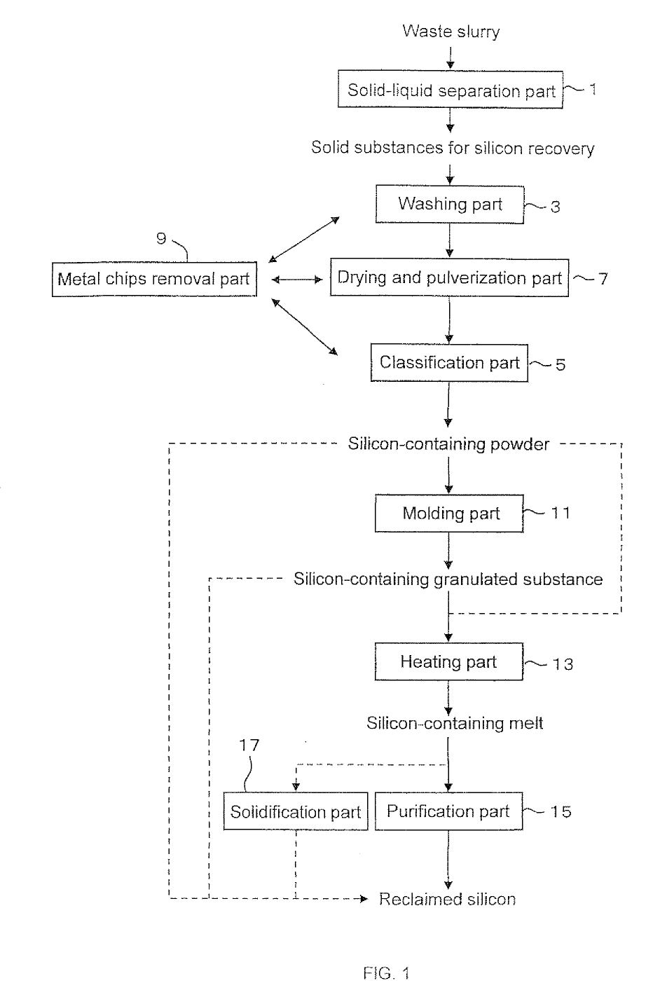

A silicon reclamation apparatus of a first embodiment of the present invention will be described by use of FIG. 1. FIG. 1 is a block diagram showing a constitution of a silicon reclamation apparatus of the present embodiment.

The silicon reclamation apparatus of the present invention contains a solid-liquid separation part 1 for obtaining solid substances for silicon recovery containing silicon chips by solid-liquid separation of a concentrate of a waste slurry or the waste slurry which is a mixture of a slurry and the silicon chips obtained by cutting or polishing a silicon chunk or a silicon wafer with use of the slurry comprising abrasive grains and coolant, a washing part 3 in which the solid substances for silicon recovery are washed with an organic solvent, and a classification part 5 in which the solid substances for silicon recovery from the washing part are classified to obtain a silicon-containing powder having a lower abrasive grain content and a higher silicon, content than before the classification.

Further, the silicon reclamation apparatus of the present embodiment includes one or more of a drying and pulverization part 7, a metal chips removal part 9, a molding part 11, a heating part 13 and a purification part 15 as required. The silicon reclamation apparatus may includes solid substances 17 in place of the purification part 15.

Hereinafter, each constituent component of the silicon reclamation apparatus will be described.

### 1-1. Solid-Liquid Separation Part

The solid-liquid separation part 1 separates a waste slurry into solid substances and liquid substances to obtain solid substances for silicon recovery.

### (1) Waste Slurry

First, the waste slurry will be described.

The waste slurry refers to a slurry in which silicon chips mix in a slurry containing abrasive grains and a coolant by cutting or polishing a silicon chunk or a silicon wafer using the slurry. The silicon reclamation apparatus of the present embodiment is an apparatus for recovering silicon chips mixed in the waste slurry to obtain reclaimed silicon. The silicon chunk is a chunk of silicon, for example, a silicon ingot. A shape of the silicon chunk is not particularly limited and a cylindrical column or a quadrangular prism is an example thereof.

Cutting or polishing of a silicon chunk or a silicon wafer is performed by use of a cutting device or a polishing device, and a used slurry discharged from the cutting device or polishing device is a waste slurry.

A multi wire saw apparatus (hereinafter, referred to as a “MWS”), which is in widespread use as a cutting device for silicon ingots, is an example of the cutting device. The MWS generally refers to a cutting device in which a wire is looped over a plurality of rollers and wound around the roller, and the wire is run while supplying a slurry containing abrasive grains and a coolant to the wire, and a substance to be cut is pressed against the wire to be cut. If a silicon ingot is cut with such a wire, silicon cutting chips, abrasive grains which were crushed and were not crushed, and metal chips, which are wear fragments of the wire, are mixed in a slurry.

the MWS, the slurry is generally repeatedly used, but a ratio of silicon contained in the slurry increases with repeated use. It is known that if this ratio becomes high (for example, if the ratio of silicon in slurry becomes 5% by weight or more), various problems that failures of the silicon, wafer, such as unevenness of thickness (often denoted by TTV), warpage or the like, occur or a broken wire is produced arise. Accordingly, a part of or all of the slurry is appropriately discharged out of the MWS as a waste slurry and a new slurry is supplied to the MWS. This slurry discharged out of the MWS is processed by the silicon reclamation apparatus of the present embodiment.

Herein, a constitution and composition of the slurry will be described. The slurry contains abrasive grains and a coolant for dispersing abrasive grains. A species of the abrasive grain is not limited and the abrasive grain is made of, for example, SiC, diamond, CBN, or alumina. A species of the coolant is not limited and the coolant may be, for example, an oil-base coolant (oil based on a mineral oil) or a water-base coolant (coolant formed by adding a glycol-base solvent (e.g., ethylene glycol, propylene glycol or polyethylene glycol), a surfactant and an organic acid to water as a base). The coolant may be a substance, which has an organic solvent (water-soluble organic solvent) such as ethylene glycol, propylene glycol or polyethylene glycol as the main component and is formed by adding additives such as an organic acid, bentonite or the like to this organic solvent in an amount 10% by weight or less (preferably 3% by weight or less). In addition, the above expression “having an organic solvent as the main component” means that for example, the coolant may include 20% by weight or less (preferably 15% by weight or less) of water.

### (2) Constitution of Solid-Liquid Separation Part and Solid-Liquid Separation Method by Solid-Liquid Separation Part

Next, a constitution of the solid-liquid separation part 1 and a solid-liquid separation method by the solid-liquid separation part 1 will be described.

The constitution of the solid-liquid separation part 1 is not particularly limited as long as it has a constitution in which a waste slurry can be separated into solid substances and liquid substances to obtain solid substances for silicon recovery, and the solid-liquid separation part 1 is configured by using solid-liquid separation apparatuses such as a centrifugal separator, a filtration device and a distillation apparatus singly or in combination of two or more of these apparatuses. Specific examples of the combination include (1) a centrifugal separator and a distillation apparatus, (2) a centrifugal separator and a filtration device, and (3) a filtration device and a distillation apparatus. In the paragraphs (1) to (3), the solid-liquid separation part 1 may contain two or more of centrifugal separators, filtration devices or distillation apparatuses. Each solid-liquid separation part may send any of the liquid substances and the solid substances after separation to the following solid-liquid separation apparatus, or may send a mixture of part of the liquid substances and the solid substances or a mixture of part of the solid substances and the liquid substances to the following solid-liquid separation apparatus.

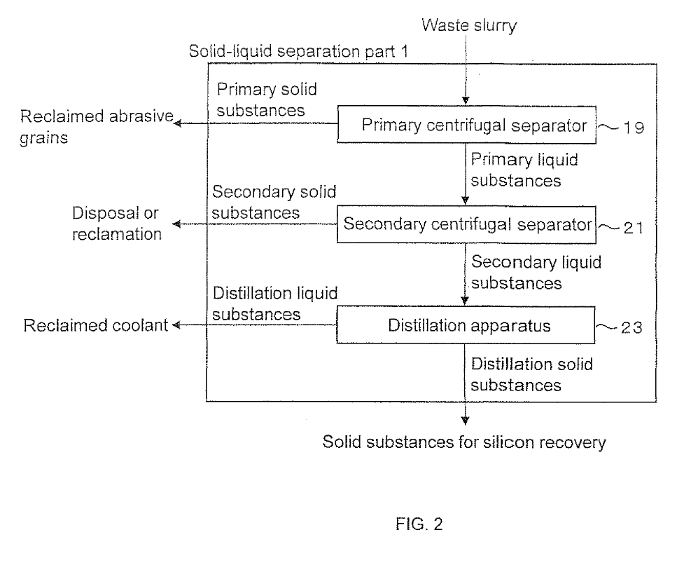

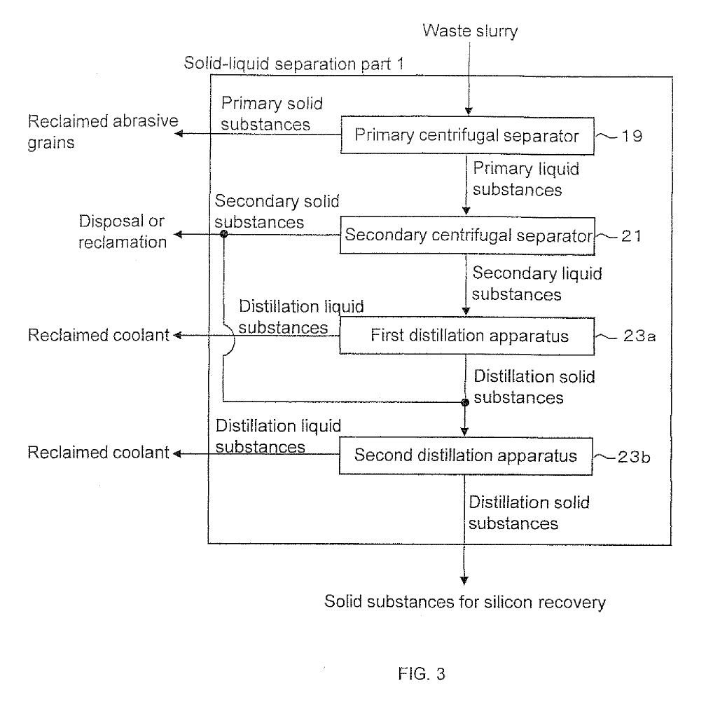

Here, constitution examples of the solid-liquid separation part 1 will be described by use of FIGS. 2 and 3. FIGS. 2 and 3 are respectively a block diagram showing a constitution of the solid-liquid separation part 1.

### (a) Example of First Constitution

An example of a first constitution of the solid-liquid separation part 1 will be described by use of FIG. 2. The solid-liquid separation part 1 of the present constitution example has a primary centrifugal separator 19, a secondary centrifugal separator 21 and a distillation apparatus 23.

The primary centrifugal separator 19 separates the waste slurry into primary liquid substances and primary solid substances by primary centrifugal separation. The primary centrifugal separation is performed at a relatively low speed and it is performed, for example, at a speed of 100 G or more and 1000 G or less. Since the primary solid substance is predominantly composed of abrasive grains, it can be recycled as reclaimed abrasive grains by the MWS or the like after washing and drying. The primary liquid substances are sent to the secondary centrifugal separator 21. In addition, the primary liquid substances may be directly sent to the distillation apparatus 23 in place of the secondary centrifugal separator 21. In this case, the secondary centrifugal separator 21 can be omitted.

The secondary centrifugal separator 21 separates the primary liquid substances into secondary liquid substances and secondary solid substances by secondary centrifugal separation. The secondary centrifugal separation is performed at a relatively high speed and it is performed, for example, at a speed of 2000 G or more and 5000 G or less. The secondary solid substances mainly include silicon and also include the abrasive grains which have not been separated by primary centrifugal separation. The secondary solid substances may be discarded, or part of or all of the secondary solid substances may be used for silicon reclamation as with an example of a second constitution described later. Since the secondary liquid substances include a large amount of silicon, solid substances for silicon recovery including a large amount of silicon can be obtained by distilling the secondary liquid substances. The secondary liquid substances are sent to the distillation apparatus 23. In addition, the secondary solid substances may be sent to the distillation apparatus 23 in place of the secondary liquid substances. Further, a mixture of part of the secondary liquid substances and the secondary solid substances, or a mixture of part of the secondary solid substances and the secondary liquid substances may be sent to the distillation apparatus 23.

The distillation apparatus 23 separates the secondary liquid substances into distillation liquid substances and distillation solid substances by distillation. The distillation is preferably performed under a reduced pressure (e.g., 5 Torr or more and 20 Torr or less). The reason for this is that since a boiling point of liquid is lowered because of the reduced pressure, the distillation becomes possible at a relatively low temperature and/or at a high speed. In addition, the distillation liquid substances can reused as a reclaimed coolant by the MWS or the like when used as it is (distillation coolant) or subjected to a reclamation treatment. The distillation solid substances are sent to the washing part 3 as solid substances for silicon recovery.

### (b) Example of Second Constitution

An example of a second constitution of the solid-liquid separation part 1 will be described by use of FIG. 3. The solid-liquid separation part 1 of the present constitution example has a primary centrifugal separator 19, a secondary centrifugal separator 21, a first distillation apparatus 23a and a second distillation apparatus 23b.

The description in the example of the first constitution is all true for the primary centrifugal separator 19.

The secondary centrifugal separator 21 is also similar to the example of the first constitution, but is different from the first constitution in that in this constitution, example, part of or all of the secondary solid substances are sent to the second distillation apparatus 23b together with distillation solid substances, described later, from the first distillation apparatus 23a.

The first distillation apparatus 23a is similar to the distillation apparatus 23 of the example of the first constitution, but the distillation solid substances from the first distillation apparatus 23a are sent to the second distillation apparatus 23b instead of being drawn out as solid substances for silicon recovery. Part of or all of the secondary solid substances and the distillation solid substances from the first distillation apparatus 23a are sent to the second distillation apparatus 23b after being mixed, or are mixed in the second distillation apparatus 23b.

The second distillation apparatus 23b is the same as the distillation apparatus 23 of the example of the first constitution except that an object of distillation is different. In addition, here, an example in which distillation is performed twice using two distillation apparatuses is shown, but the distillation may be performed twice using one distillation apparatus. In this case, the second distillation apparatus 23b is omitted, and part of or all of the secondary solid substances and the distillation solid substances from the first distillation apparatus 23a are sent to the first distillation apparatus 23a again to be distilled again.

### 1-2, Washing Part

Next, a washing part 3 will be described. In the washing part 3, the solid substances for silicon recovery are washed with an organic solvent. The solid substances for silicon recovery generally contains about 5 to 20% by weight of residual organic substances originating from a coolant (hereinafter, referred to as a “residual coolant”) such as a glycol base solvent and additives and if the solid substances for silicon recovery is directly used, it causes the reduction in a purity of the reclaimed silicon. Further, the residual organic substances cause forms SiC when the silicon-containing powder is melted by a heating part 13 and causes unnecessary SiC to be generated in a silicon ingot formed through solidification of molten silicon. Therefore, the solid substances for silicon recovery are washed for the purpose of decreasing a residual coolant concentration.

An organic solvent to be used is preferably a solvent having compatibility with a coolant. The reason for this is that in this ease, a remaining coolant is easily extracted to the organic solvent. The organic solvent is, for example, alcohol having 1 to 6 (preferably a range between any adjacent two integers of 1, 2, 3, 4, 5 and 6) carbon atoms or ketone having 3 to 6 (preferably a range between any adjacent two integers of 3, 4, 5 and 6) carbon atoms. Specific examples of such alcohol include methanol, ethanol, isopropyl alcohol, butyl alcohol and the like. Specific examples of such ketone include acetone, methyl ethyl ketone and the like. The organic solvent may be a mixture of plural kinds of organic solvents. Further, the organic solvent preferably has a boiling point lower than a coolant. Specifically, the organic solvent preferably has a boiling point lower than a coolant by 50° C. or higher (preferably 60° C. or higher, 70° C. or higher, 80° C. or higher, 90° C. or higher, or 100° C. or higher). This is because an organic solvent is generally evaporated in a post-process to be removed and if the boiling point of the organic solvent is low, the organic solvent is easily evaporated.

A constitution of an apparatus used in the washing part 3 is not particularly limited as long as it can extract a residual coolant in the solid substances for silicon recovery into the organic solvent to remove it, and for example, an apparatus, which has a function of mixing the solid substances for silicon recovery and the organic solvent and extracting at least a part of the remaining organic substances contained in solid substances for silicon recovery by vibration, rotation or stirring into the organic solvent and removing the organic solvent, can be employed. The removal of the organic solvent can be performed by centrifugal separation and filtration. Therefore, the washing part 3 is composed of, for example, an stirring device having stirring blades which stir a mixture of the solid substances for silicon recovery and the organic solvent, charged into a container, and a centrifugal separation or a filtration device which removes the organic solvent from the stirred mixture.

### 1-3. Drying and Pulverization Part

Next, a drying and pulverization part 7 will be described. The drying and pulverization part 7 has a function of removing an organic solvent remaining in the solid substances for silicon recovery after washing and pulverizing the solid substances for silicon recovery. The drying and the pulverizing may be carried out simultaneously, or the pulverizing may be carried out after the drying, or they may be carried out in the reverse order. Drying of the solid substances for silicon recovery can be performed, for example, by heating the solid substances for silicon recovery or reducing a pressure of a surrounding atmosphere of the solid substances for silicon recovery. Pulverization of the solid substances for silicon recovery can be performed by using a publicly known apparatus such as a pulverization apparatus using pulverizing blades, a ball mill, a jet mill and a vibrating vacuum dryer.

Since the solid substances for silicon recovery may be subjected to air-drying or may be dried during the classification by a classification apparatus 5 described later, drying of the solid substances for silicon recovery can be omitted. Further, the solid substances for silicon recovery may be pulverized during the classification by a classification apparatus 5 such as a cyclone, pulverization of the solid substances for silicon recovery can be omitted. Therefore, the drying and pulverization part 7 may be a drying part or a pulverization part, or may be omitted.

### 1-4. Classification Part

Next, a classification part 5 will be described. In the classification part 5, the solid substances for silicon recovery after washing are classified. It is one of objects of classification to obtain a silicon-containing powder having a lower abrasive grain content and a higher silicon content than before the classification. The classification is a method of classifying particles based on particle parameters such as a particle size, a density and the like. The classification part 5 can be composed of a sieve, an inertia classifier or a centrifugal classifier.

If the solid substances for silicon recovery are classified, contents of silicon, abrasive grain and metal respectively vary depending on values of the particle parameters.

For example, when the particle parameter is a particle size, the content of silicon vary depending on the particle size (for example, a content of silicon increases as a particle size increases up to 5 μm, the content of silicon is the highest at a particle size of 5 μm, and the content of silicon decreases as the particle size increases in a particle size range more than 5 μm.). A content of silicon of a group of particles having a particle size within a predetermined range (for example, 1 μm or more and less than 10 μm) is higher than a group of particles having another particle size (for example, less than or 10 μm or more), and is higher than the solid substances for silicon recovery before the classification. In this case, a content of abrasive grain of the former group is generally lower than the latter group, and is lower than the solid substances for silicon recovery before the classification. Therefore, if drawing out the former group from the classification part 5, a silicon-containing powder having a lower abrasive grain content and a higher silicon content than before the classification can be obtained.

Further, a content of metal of a group of particles having a particle size within a predetermined range (for example, less than 1 μm, or 0.1 μm or more and less than 1 μm) is higher than a group of particles having another particle size (for example, 1 μm or more), and is higher than the solid substances for silicon recovery before the classification. Therefore, by removing the group in which the content of metal is high, a content of metal in the silicon-containing powder can be reduced to a lower level than before the classification.

In addition, in the present specification, a “particle size” means a particle diameter measured by a method according to JIS R 1629. “The powder having a particle size range of less than X μm” means a powder in which 98% of particles have a particle size of less than X μm. “The powder having a particle size range of Y μm or more and less than Z μm” means a remaining powder after eliminating “the powder having a particle size range of less than Y pin” from “the powder having a particle size range of less than Z μm”.

Even though a particle parameter is other than a particle size, the above description is applied in the same manner, and a silicon-containing powder having a lower abrasive grain content and a higher silicon content than before the classification can be obtained by the classification.

The silicon-containing powder may be directly recovered as reclaimed silicon, or may be sent to a molding part 11 to be granulated, or may be sent to a heating part 13 to be melted.

Here, a specific example of classification will be described.

(1) Separation into Two Species of Powder

In this example, the solid substances for silicon recovery are separated into a first powder which has a first particle size range and is predominantly composed of silicon, and a second powder which has a second particle size range and a higher abrasive grain content than the first powder.

For example, it is apparent that when SiC having a particle size of 10 μm or more and 30 μm or less is used as abrasive grains, the first powder having a particle size range of 0.1 μm or more and less than 10 μm, which is obtained by classification, is predominantly composed of silicon and the second powder having a particle size range of 10 μm or more and 30 μm or less, which is obtained by classification, has a higher abrasive grain content than the first powder. The second powder can be used for reclaiming the abrasive grains.

(2) Separation into Three Species of Powder

In this example, the solid substances for silicon recovery are separated into a third powder which has a third particle size range and is predominantly composed of silicon, a fourth powder which has a fourth particle size range and a higher abrasive grain content than the third powder, and a fifth powder which has a fifth particle size range and a higher metal content than the third powder.

Most of metal chips (contain iron as a main ingredient) originating from a wire have a particle size less than 1 μm. Accordingly, it is apparent that the third powder having a particle size range of 1 μm or more and less than 10 μm, which is obtained by classification, is predominantly composed of silicon and the fourth powder having a particle size range of 10 μm or more and less than 30 μm, which is obtained by classification, has a higher abrasive grain content than the third powder and the fifth powder having a particle size range of 0.1 μm or more and less than 1 μm, which is obtained by classification, has a higher metal content than the third powder. The fourth powder can be used for reclaiming the abrasive grains.

By thus classifying the solid substances for silicon recovery into three or more kinds of powders and removing the powder (the fifth powder in the above example) having a higher metal content, it is possible to obtain reclaimed silicon which prevents metal originating from a wire from mixing in the reclaimed silicon with no need to remove metal using an aqueous acid solution such as sulfuric acid, nitric acid or the like as usual.

### 1-5. Metal Chips Removal Part

Next, a metal chips removal part 9 will be described. The metal chips removal part 9 has a function of eliminating with use of a magnetic field a ferromagnetic metal (e.g., iron) chips (for example, originating from a wire for cutting silicon) mixed in the waste slurry during cutting or polishing a silicon chunk or a silicon wafer. The metal chips may also be removed with silicon or SiC adhering to the metal chips. The metal chips removal part 9 is composed of a magnet, for example.

The removal of the metal chips can be performed for any one or more of solid substances for silicon recovery in a state of being dispersed in an organic solvent for washing, solid substances for silicon recovery in a powder state (e.g., solid substances for silicon recovery after washing by the washing part, or solid substances for silicon recovery obtained by pulverizing the solid substances for silicon recovery), a powder conveyed by a gas stream during the classification, and a silicon-containing powder after the classification. Therefore, the metal chips removal part 9 can be installed in any one or more of, for example, the washing part 3, the drying and pulverization part 7 and the classification part 5. A concentration of metal in the reclaimed silicon can be reduced by removing the metal chips from the solid substances for silicon recovery or the like. Further, the wire used in the MWS often contains phosphorus, and in this case, the metal chips mixed in the waste slurry contain phosphorus. Since the phosphorus is a component unnecessary for fabrication of a p-type solar cell, it is preferably removed before melting the silicon, but in accordance with the present embodiment, phosphorus is removed together with the removal of metal chips.

### 1-6. Molding Part

Next, a molding part 11 will be described. A constitution of the molding part 11 is not particularly limited as long as the molding part 11 is an apparatus having a function of applying a pressure to the silicon-containing powder to granulate it into a plate shape, a block shape or a pellet shape. A pressure press-type granulating apparatus or a pressure roller-type granulating apparatus can be used in the molding part 11. With respect to molding conditions, the silicon-containing powder can be granulated, for example, at a press pressure of 3 to 60 ton/cm² at room temperature. Further, heating may be carried out during applying a pressure. By granulating the silicon-containing powder, the silicon-containing powder becomes easy to handle, and its thermal conductivity becomes smooth and therefore it is easy to be melted.

The silicon-containing powder (in other words, silicon-containing granulated substance) granulated by the molding part 11 may be directly recovered as reclaimed silicon, or may be sent to a heating part 13.

### 1-7. Heating Part

Next, a heating part 13 will be described. The heating part 13 has a function of heating the silicon-containing powder before granulation or after granulation to melt it. It is desirable that the heating part 13 can heat the silicon-containing powder to a melting point (generally, set at 1410 to 1420° C.) of silicon and higher, can exhaust gas, and has an intake portion of inert gases.

Further, the heating part 13 can preferably realize the following two-stage heating step.

First, the silicon-containing powder was fired at a temperature (for example, 400° C. or higher and 600° C. or lower) lower than a melting point of silicon under a reduced pressure (e.g., 1 Torr or less) or in the presence of an inert gas (e.g., argon gas of 0.8 atm) to eliminate a trace of organic substances which could not be eliminated by washing.

Thereafter, the silicon-containing powder is heated at a temperature (for example, 1800° C.) of a melting point of silicon or higher to melt silicon. This heating step is preferably realized by the same apparatus, but the firing step and the melting step may be realized by separate apparatuses.

A silicon-containing melt which is the silicon-containing powder melted by the heating part 13 is then sent to a purification part 15 or a solidification part 17. In addition, the heating part 13 and the purification part 15 or the solidification part 17 can be constructed of a single apparatus. In this case, the silicon-containing melt formed by melting by the heating part 13 is not sent to another apparatus but is directly purified or solidified.

The solidification part 17 has a function of naturally cooling or forced-cooling the silicon-containing melt to solidify it, and thereby a silicon chunk can be obtained. This silicon chunk can be recovered as reclaimed silicon.

### 1-8. Purification Part

Next, a purification part 15 will be described. The purification part 15 has a function of eliminating impurities contained in the silicon-containing melt obtained by melting the silicon-containing powder. The purification part 15 eliminates impurities, for example, by use of various publicly known purification techniques (e.g., removal of phosphorus under vacuum melting, removal of segregation impurities through unidirectional coagulation) in conventional molding of melted polycrystalline silicon. Thereby, a silicon chunk from which impurities are eliminated is obtained.

The silicon chunk, obtained through the purification part 15, from which impurities are eliminated can be directly recovered as reclaimed silicon.

### 2. Second Embodiment

Next, a silicon reclamation apparatus of a second embodiment of the present invention will be described. A constitution of the silicon reclamation apparatus of the present embodiment is similar to that of the first embodiment, but is different in an object to be treated. In the first embodiment, the waste slurry itself is subjected to the treatment, but in the second embodiment, a concentrate of the waste slurry is subjected to the treatment. The constitution of the apparatus of the present embodiment is basically the same as the first embodiment, and the contents described in the first embodiment basically hold true for this embodiment.

“A concentrate of the waste slurry” refers to a substance obtained by concentrating the waste slurry before charging it into the silicon reclamation apparatus of the present embodiment. The concentrate of the waste slurry is usually in the form of mud or clay but it may be in forms other than these forms.

“Concentration of a waste slurry” means that a part of a coolant is removed from the waste slurry. A method of concentrating the waste slurry is not particularly limited, and examples of the concentration method include filtration, centrifugal separation or distillation, or a method of combination of two or more of these operations.

An example of “the concentrate of the waste slurry” of the present embodiment is the concentrate of the waste slurry generated in a plant (including a plant fabricating solar cells or IC chips from a produced silicon wafer) producing silicon ingots or silicon wafers.

Conventionally, such a waste slurry generated in a plant is principally subjected to disposal by landfill after concentration, and facilities and methods for recovering and transporting silicon are often established, but the silicon reclamation apparatus of the present embodiment can draw out reclaimed silicon from the concentrate of the waste slurry hitherto disposed of by a simple method, and thereby the reclaimed, silicon is obtained and simultaneously an amount of wastes can be reduced.

Further, since the concentrate of the waste slurry has been already concentrated, the solid-liquid separation apparatus 1 can be a relatively simple constitution. For example, the solid-liquid separation apparatus 1 can be composed of a single distillation apparatus. Therefore, in accordance with the present embodiment, an apparatus constitution can be simplified:

Various features shown in the above embodiments can be combined with one another. When one embodiment includes a plurality of features, one feature or plural features of these features are appropriately picked up and picked up features may be employed singly or in combination for the present invention.

Further, in the above embodiments, the present invention has been described taking a silicon reclamation apparatus as an example, but the description on the silicon reclamation apparatus basically holds true with the method of reclaiming silicon

### Example

Example of the silicon reclamation apparatus and the method of reclaiming silicon of the present invention will be described by use of specific numerical values. The present example is an example in which silicon is reclaimed using silicon reclamation apparatuses shown in FIGS. 1 and 2, and the present invention will be described referring to FIGS. 1 and 2.

In the present example, a waste slurry, discharged from a MWS in which a slurry formed by mixing abrasive grains in a weight ratio of 1:1 in a coolant prepared by adding about 15% by weight of water, a dispersant facilitating the dispersion of the abrasive grains and about 1% by weight of an organic acid as a pH regulator to propylene glycol was used, was used.

Cutting chips made from silicon are contained in an amount about 10 to 12% by weight in this waste slurry.

### 1. Method of Reclaiming Silicon

First, a method of reclaiming silicon will be described.

### 1-1. Solid-Liquid Separation Step

First, in the solid-liquid separation part 1, a waste slurry was separated into solid substances and liquid substances to obtain solid substances for silicon recovery. Facilities including a primary centrifugal separator 19, a secondary centrifugal separator 21 and a distillation apparatus 23 are used for the solid-liquid separation part 1. The solid-liquid separation was performed in combination of primary centrifugal separation, secondary centrifugal separation and distillation. Hereinafter, this step will be described in detail.

### (1) Primary Centrifugal Separation Step

First, a waste slurry was charged into the primary centrifugal separator 19 and separated into primary solid substances (heavy specific gravity liquid) predominantly composed of abrasive grains and primary liquid substances (low specific gravity liquid) predominantly composed of a coolant and cutting chips (mainly including silicon) by operating the primary centrifugal separator 19 in such a way that a centrifugal force is 500 G (a relatively low centrifugal force, generally referred to as “primary separation”).

### (2) Secondary Centrifugal Separation Step

Next, the primary liquid substances (low specific gravity liquid) were charged into the secondary centrifugal separator 21 and separated into secondary liquid substances predominantly composed of a coolant and secondary solid substances predominantly composed of cutting chips and abrasive grains by operating the secondary centrifugal separator 21 in such a way that a centrifugal force is 3500 G (a relatively high centrifugal force, generally referred to as “secondary separation”).

Here, components of the secondary liquid substances and the secondary solid substances are shown in the following Table 1. In addition, in this example, 80 kg of the secondary liquid substances and 100 kg of the secondary solid substances were yielded from 500 kg of the waste slurry. Units of numerical values in Table 1 are % by weight.

TABLE 1

| | | SiC | Coolant | Metal | Other | Total |
|---|---|---|---|---|---|---|
| | Si conc. | conc. | conc. | conc. | conc. | weight |
| Secondary | 13 | 5 | 80 | 1 | 1 | 80 kg |
| liquid | | | | | | |
| substances | | | | | | |
| Secondary | 60 | 20 | 18 | 1 | 1 | 100 kg |
| solid | | | | | | |
| substances | | | | | | |

### (3) Distillation Step

Next, the secondary liquid substances were charged into the distillation apparatus 23 and distilled at 160° C. in an ultimate vacuum of 10 Torr to obtain solid substances for silicon recovery and a reclaimed coolant. The components of the obtained solid substances for silicon recovery are shown in the following Table 2.

TABLE 2

| | | SiC | Coolant | Metal | Other | Total |
|---|---|---|---|---|---|---|
| | Si conc. | conc. | conc. | conc. | conc. | weight |
| wt % | 66 | 12 | 10 | 6 | 6 | 12.8 kg |

The solid substances for silicon recovery obtained here contained residual organic substances (propylene glycol, an organic acid, etc.) originating from a coolant in an amount of about 10% by weight and were coagulated by virtue of these organic substances as a binder. The particle size distribution of the solid substances is shown in the following Table 3. A proportion of particles having a particle size less than 0.001 mm was nearly 0% by weight. In addition, in this example, the particle size distribution was measured with a particle size distribution analyzer (Model: LA-300) manufactured by Horiba Ltd.

TABLE 3

| | particle size | | | | |
|---|---|---|---|---|---|
| | 0.001 mm | 0.02 mm | 0.1 mm | 1 mm | 10 mm |
| | or more | or more | or more | or more | or more |
| wt % | 10 | 20 | 33 | 32 | 5 |

### 1-2. Washing Step

Next, the solid substances for silicon recovery were washed with IPA.

Specifically, the solid substances for silicon recovery were mechanically pulverized and stirred together with IPA, and then they were subjected to solid-liquid separation by centrifugal separation. Metal chips, which had been contained in the solid substances for silicon recovery, were dispersed in an stirred solution based on IPA, and ferromagnet-containing metal chips included in this stirred solution were removed using a metal chips removal part 9 made of a magnet having a magnetic force of 1.4 T.

### 1-3. Drying and Pulverization Step

Next, in the drying and pulverization part 7, the washed solid substances for silicon recovery obtained through solid-liquid separation were dried at 80° C. and then were mechanically pulverized again to fine powder. Next, ferromagnet-containing metal chips contained in the solid substances for silicon recovery were removed using a metal chips removal part 9.

### 1-4. Classification Step

Next, in the classification part 5 including a centrifugal classification apparatus, the solid substances for silicon recovery were separated into a powder A having a particle size range of 8 μm or more, a powder B having a particle size range of 1 μm or more and less than 8 μm, and a powder C having a particle size range less than 1 μm through classification. The classification was performed by two-stage centrifugal classification. The solid substances for silicon recovery were separated into the powder A and a powder other than that at the first-stage centrifugal classification. The powder other than the powder A was separated into the powder B and the powder C at the second-stage centrifugal classification.

As is apparent from Table 5 on related experiments described later, the powder B has a higher silicon content than the powder A and the powder C. The powder A has a higher content of abrasive grain containing SiC than the powder B and the powder C. The powder C has a higher metal content than the powder A and the powder B. Hereinafter, the powder B will be referred to as a “silicon-containing powder”.

### 1-5. Molding Step

Next, in the molding part 11, the silicon-containing powder was granulated at a press pressure of 3 ton/cm² at room temperature to be formed into a pellet having a size of about 1 mm×1 mm×0.5 mm.

### 1-6. Heating and Purification Steps

Next, in an apparatus combining the heating part 13 and the purification part 15, firing of pellet-shaped silicon after granulation, melting and purification were performed.

Specifically, the pellet-shaped silicon after granulation was put in a graphite crucible and fired for 1 hour at 600° C. by resistance heating in a vacuum of 10 Torr and thereby a trace of organic substances, which remained slightly in the pellet-shaped silicon, were removed. Next, silicon was melted at 1800° C. by high frequency induction heating in an atmosphere of argon (Ar), and thereafter the unidirectional coagulation of the silicon was performed by lowering a crucible temperature from a lower portion of the crucible to obtain a silicon chunk. Furthermore, an upper portion (portion in which metal impurities were concentrated) of the obtained silicon chunk was cut and eliminated. This operation of unidirectional coagulation and removal of a portion in which impurities were concentrated was repeated twice to obtain a reclaimed silicon ingot.

### 2. Evaluation of Reclaimed Silicon

Next, the above-mentioned reclaimed silicon ingot was cut in a thickness of 250 μm with a MWS to obtain a reclaimed silicon wafer (polycrystalline substrate). A solar cell was prepared by use of this reclaimed silicon wafer and photoelectric conversion characteristics of the solar cell were measured.

Characteristics of the solar cell in which the reclaimed silicon wafer in this Example was used and a solar cell in which a common silicon wafer for a solar cell was used are shown in the following Table 4.

In table 4, levels of the characteristics of the solar cell using a common silicon wafer for a solar cell is assumed to be 100%, and characteristics of the solar cell in this Example were compared with these characteristics.

TABLE 4

| | Pmax (%) | Isc (%) | Voc (%) |
|---|---|---|---|
| Common silicon | 100 | 100 | 100 |
| Reclaimed silicon | 95 | 95 | 98 |

It could be verified from Table 4 that the differences in characteristics between the solar cell in which the reclaimed silicon wafer was used and the solar cell in which a common silicon wafer for a solar cell was used were small, and the reclaimed silicon ingot obtained in this Example can be used as silicon for a solar cell.

### 3. Related Experiments

Next, Experiments related to Example described above will be described.

### 3-1. Experiments for Investigating Effects of Classification

In this experiment, the steps up to “1-4. Classification step” were performed in the same manners as in Example described above. However, in this experiment, the removal of ferromagnet-containing metal chips by the metal chips removal part 9 was not performed. Further, through the classification similar to that of Example, the solid substances for silicon recovery were separated into a group having a particle size range of 8 μm or more, a group having a particle size range of 1 μm or more and less than 8 μm and a group having a particle size range less than 1 μm. The composition of the solid substances for silicon recovery before the classification and the composition of the respective groups after the classification are shown in Table 5. Units of numerical values in Table 5 are % by weight.

TABLE 5

| | | | 1 μm or more | |
|---|---|---|---|---|
| | Before the | 8 μm or | and less than | Less than |
| | classification | more | 8 μm | 1 μm |
| Weight | 100 | 18 | 55 | 27 |
| Si | 73.33 | 36.67 | 84.67 | 74.69 |
| SiC | 13.33 | 50.00 | 4.44 | 7.00 |
| Metal (iron) | 6.67 (5.33) | 6.67 (5.33) | 5.33 (4.27) | 9.38 (7.51) |
| Other | 6.67 | 6.67 | 5.56 | 8.93 |

Referring to Table 5, it is apparent that the group having a particle size range less than 1 μm has a higher metal content than those of the other two groups and that before the classification. Further, it is apparent that the group having a particle size range of 8 μm or more has a higher SIC content than those of the other two groups and that before the classification. Further, it is apparent that the group having a particle size range of 1 μm or more and less than 8 μm has a higher Si content than those of the other two groups and that before the classification. Furthermore, it is apparent that the group having a particle size range of 1 μm or more and less than 8 μm has a lower SiC content than those of the other two groups and that before the classification.

Accordingly, by recovering only the group having a particle size range of 1 μm or more and less than 8 μm, reclaimed silicon of higher purity can be obtained. Further, if the group having a particle size range less than 1 μm is not included in the reclaimed silicon, a metal content in the reclaimed silicon can be reduced. Further, in the group having a particle size range less than 1 μm, by increasing number of cycles of unidirectional coagulation and removal of a portion of concentrated impurities, reclaimed silicon of high purity can be obtained.

### 3-2. Experiments for Investigating Effect of Metal Chips Removal Part

In this experiment, the steps up to “1-3. Drying and pulverizing step” were performed in the same manners as in Example described above. In order to investigate an effect of the metal chips removal part 9, the composition of a solid substances for silicon recovery in which ferromagnet-containing metal chips were not removed and the composition of a solid substances for silicon recovery in which ferromagnet-containing metal chips were removed, with a magnet having a magnetic force of 1.4 T were investigated. The results are shown in Table 6. Units of numerical values in Table 6 are % by weight.

TABLE 6

| | | Remove with a |
|---|---|---|
| | | magnet having a |
| | No remove | magnetic force of 1.4 T |
| Weight | 100 | 96 |
| Si | 73.33 | 78.01 |
| SiC | 13.33 | 13.19 |
| Metal (iron) | 6.67 (5.33) | 2.20 (1.76) |
| Other | 6.67 | 6.60 |

From Table 6, it is found that the content of metal is decreased surely in the waste slurry from which ferromagnet-containing metal chips are eliminated using a magnet. Thereby, it was found that the metal chips removal part 9 is effective for decreasing the content of metal chips.

1. A silicon reclamation apparatus comprising:
a solid-liquid separation part for obtaining solid substances for silicon recovery containing silicon chips by solid-liquid separation of a concentrate of a waste slurry or the waste slurry which is a mixture of a slurry and the silicon chips obtained by cutting or polishing a silicon chunk or a silicon wafer with use of the slurry comprising abrasive grains and coolant;
a washing part in which the solid substances for silicon recovery are washed with an organic solvent; and
a classification part in which the solid substances for silicon recovery from the washing part are classified to obtain a silicon-containing powder having a lower abrasive grain content and a higher silicon content than before the classification.

2. The silicon reclamation apparatus according to claim 1, wherein the solid-liquid separation part, the washing part and the classification part are configured in such a way that the solid substances for silicon recovery or the silicon-containing powder does not come into contact with water, an aqueous acid solution or a solution predominantly composed of at least one of water and the aqueous acid solution.

3. The silicon reclamation apparatus according to claim 1,
wherein the waste slurry contains metal chips mixed during cutting or polishing a silicon chunk or a silicon wafer, and
in the classification part, a metal-containing powder having a higher metal content than before the classification is removed.

4. The silicon reclamation apparatus according to claim 1,
wherein the waste slurry contains ferromagnetic metal chips mixed during cutting or polishing a silicon chunk or a silicon wafer, and
the silicon reclamation apparatus further comprises a metal chips removal part eliminating the metal chips using a magnetic field.

5. The silicon reclamation apparatus according to claim 1, further comprising a molding part in which a pressure is applied to the silicon-containing powder to granulate it.

6. The silicon reclamation apparatus according to claim 5, further comprising a heating part in which the silicon-containing powder before granulation or after granulation is fired at a temperature lower than a melting point of silicon and then melted at a temperature of a melting point of silicon or higher.

7. The silicon reclamation apparatus according to claim 6, wherein the silicon reclamation apparatus further comprises a purification part which eliminates impurities contained in a silicon-containing melt obtained by melting the silicon-containing powder.

8. A method of reclaiming silicon, comprising:
a solid-liquid separation step in which solid substances for silicon recovery containing silicon chips are obtained by solid-liquid separation of a concentrate of a waste slurry or the waste slurry which is a mixture of a slurry and the silicon chips obtained by cutting or polishing a silicon chunk or a silicon wafer with use of the slurry comprising abrasive grains and coolant;
a washing step in which the solid substances for silicon recovery are washed with an organic solvent; and
a classification step in which the solid substances for silicon recovery from the washing step are classified to obtain a silicon-containing powder having a lower abrasive grain content and a higher silicon content than before the classification.

9. The method of reclaiming silicon according to claim 8, wherein the solid-liquid separation step, the washing step and the classification step are performed in such a way that the solid substances for silicon recovery or the silicon-containing powder does not come into contact with water, an aqueous acid solution or a solution predominantly composed of at least one of water and the aqueous acid solution.

10. The method of reclaiming silicon according to claim 8,
wherein the waste slurry contains metal chips mixed during cutting or polishing a silicon chunk or a silicon wafer, and
in the classification step, a metal-containing powder having a higher metal content than before the classification is removed.

11. The method of reclaiming silicon according to claim 8,
wherein the waste slurry contains ferromagnetic metal chips mixed during cutting or polishing a silicon chunk or a silicon wafer, and
the method of reclaiming silicon further comprises a metal chips removal step of eliminating the metal chips using a magnetic field.

12. The method of reclaiming silicon according to claim 8, further comprising a molding step of applying a pressure to the silicon-containing powder to granulate it.

13. The method of reclaiming silicon according to claim 12, further comprising a heating step in which the silicon-containing powder before granulation or after granulation is fired at a temperature lower than a melting point of silicon and then melted at a temperature of a melting point of silicon or higher.

14. The method of reclaiming silicon according to claim 13, further comprising a purification step of eliminating impurities contained in a silicon-containing melt obtained by melting the silicon-containing powder.
